(19) United States
(12) Patent Application Publication
(10) Pub. No.: US 2002/0158535 A1
(43) Pub. Date: Oct. 31, 2002

(54) Alternator rotor with titanium filler

(76) Inventor: Michael J. Maul, Tequesta, FL (US)

Correspondence Address: WEBB ZIESENHEIM LOGSDON, ORKIN & HANSON, P.C., 700 Koppers Building, 436 Seventh Avenue, Pittsburgh, PA, 15219-1818, US

(21) Appl. No.: 10/109,607

(22) Filed: Mar. 28, 2002

Related U.S. Application Data
(60) Provisional application No. 60/279,913, filed on Mar. 29, 2001.

(51) Int. Cl. H02K 21/12

(52) U.S. Cl. 310/156.08; 310/156.28

(57) ABSTRACT

The alternator rotor includes a polygonal shaped rotating core defining a plurality of flat faces. A plurality of polygonal shaped permanent magnets cooperate with the flat faces of the core. The permanent magnets form voids between adjacent permanent magnets. A plurality of titanium or titanium alloy filler pieces is positioned, respectively, in the voids created between adjacent permanent magnets. A compressive outer sleeve encloses the core, permanent magnets, and titanium filler pieces to form the alternator rotor.

### CROSS-REFERENCE TO RELATED APPLICATION

This application claims the benefit of earlier filed U.S. Provisional Patent Application Serial No. 60/279,913, filed Mar. 29, 2001, entitled “Alternator Rotor Corner Filler Material”, which is hereby incorporated by reference in its entirety.

### BACKGROUND OF THE INVENTION

1. Field of the Invention

The present invention relates to magnetic rotors for use in electrical machinery and, more particularly, to magnetic alternator rotors for use in gas turbine engines that include corner filler spacers.

2. Description of the Prior Art

Rotors for electrical machinery typically include permanent magnets located at multiple pole locations around a central axis (i.e., rotor shaft) of the rotors. The permanent magnets are generally made of ferromagnetic materials and are mounted on the rotating central shaft of the rotor. The permanent magnets are typically rectangular shaped and voids are formed between adjacent magnets when they are mounted on the rotor shaft. An outer sleeve generally encloses the rotor permanent magnets to provide strength to the assembled rotor structure.

It is known in the art to fill the voids created between the rectangular shaped permanent magnets with corner filler pieces, which may also be referred to as corner filler spacers. One type of corner filler piece known in the art is made of composite, epoxy resin material. Such epoxy resin filler pieces do not adequately withstand high temperatures to which electrical machinery containing rotors are often exposed. In addition, it is advantageous in the construction of alternator rotors to tightly compress the permanent magnets and filler pieces of the rotor with an outer sleeve. Epoxy resin filler pieces often deform under the compressive pressure applied by the outer sleeve of the rotor. A typical rotor for an electrical machine is illustrated in FIG. 1 and includes corner filler pieces made of epoxy resin material. The following United States patents disclose the use of nonmetallic corner filler pieces in rotors for electrical machinery, the disclosures of which are incorporated herein by reference: U.S. Pat. Nos. 2,985,779 to Flaningam et al.; 4,633,113 and 4,674,178 both to Patel; 5,452,590 to Vigili; and 5,488,260 to Heyraud.

Referring to FIG. 1, a known rotor 10 includes four (4) permanent magnets or poles 12 arranged around a central shaft or core 14. The permanent magnets 12 and core 14 are polygonal shaped. The permanent magnets 12 are enclosed by an outer sleeve 16. The voids or spaces between the permanent magnets are occupied by epoxy resin filler pieces 18. The entire assembly is enclosed by outer sleeve 16, which is also made of epoxy resin material.

It is further known in the art to utilize corner filler pieces in rotors that are made of metal. Metal rotors are inherently stronger than rotors made of epoxy material and, therefore, better able to withstand increased temperatures and compressive forces. A known metal used in rotor corner filler pieces is aluminum. It is also known to combine aluminum with epoxy resin to form composite corner filler pieces for rotors. Examples of metallic or composite metallic materials used in rotor corner filler pieces are disclosed by U.S. Pat. Nos. 3,169,203 to Lavin et al.; 4,117,360 to Richter; 4,486,678 to Olson; and 4,631,435 to McCarty, the disclosures of which are incorporated herein by reference.

In view of the foregoing, it is an object of the present invention to provide a metallic corner filler piece for an alternator rotor that is better able to withstand high temperatures and compressive forces often present in alternator rotors. It is a further object of the present invention to improve upon the prior art.

### SUMMARY OF THE INVENTION

The above objects are accomplished with a titanium or titanium alloy filler piece in accordance with the present invention that may be used with a permanent magnet alternator rotor. The alternator rotor in accordance with the present invention will include a polygonal shaped rotating core that defines a plurality of flat faces. A plurality of polygonal shaped permanent magnets cooperate with the flat faces of the core. The permanent magnets define voids between adjacent permanent magnets. A plurality of titanium filler pieces are positioned, respectively, in the voids defined between adjacent permanent magnets. A compressive outer sleeve encloses the core, permanent magnets, and titanium filler pieces.

The titanium filler pieces may be made of titanium alloys. The compressive outer sleeve may be made of metal, epoxy resin, or composite material made of metal and epoxy resin. The core may be made of ferromagnetic material.

The alternator rotor preferably includes at least four permanent magnets arranged around the core. The permanent magnets may be substantially rectangular shaped and the cooperating titanium filler pieces may be substantially triangular shaped to fit between the voids defined between adjacent permanent magnets.

The present invention is also a method of assembling an alternator rotor comprising the steps of: providing a polygonal shaped rotating core defining a plurality of flat faces; arranging a plurality of polygonal shaped permanent magnets around the core, with the permanent magnets having flat faces cooperating with the flat faces of the core, and with the permanent magnets defining voids between adjacent permanent magnets; positioning a plurality of titanium filler pieces in the voids defined between adjacent permanent magnets; and enclosing the core, permanent magnets, and titanium filler pieces with a compressive outer sleeve.

The present invention is also a method of retrofitting corner pieces in an existing alternator rotor. The method may include the steps of: providing an existing alternator rotor having a central core, permanent magnets arranged around the central core, corner filler pieces separating adjacent permanent magnets, and an outer sleeve, with the outer sleeve enclosing the central core, permanent magnets and corner filler pieces; and removing the existing corner filler pieces and replacing the existing corner filler pieces with titanium filler pieces.

Further details and advantages of the present invention will become apparent from the following detailed description read in conjunction with the drawings.

### BRIEF DESCRIPTION OF THE DRAWINGS

FIG. 1 is a cross-sectional, front perspective view of a prior art rotor incorporating epoxy resin corner filler pieces; and

FIG. 2 is an exploded front perspective view of an alternator rotor incorporating titanium corner filler pieces in accordance with the present invention; and

FIG. 3 is a cross-sectional view of the assembled alternator rotor of FIG. 2.

### DETAILED DESCRIPTION OF THE PREFERRED EMBODIMENT

FIGS. 2 and 3 shows an alternator rotor 30 made in accordance with the present invention. The rotor 30 includes a rotor shaft or core 32. The core 32 is rotatable about a central axis L. The core 32 is substantially polygonal shaped in cross section. Preferably, the core 32 is rectangular or square in cross section. A plurality of permanent magnets 34 forms the poles of the rotor 30 in a conventional manner. The magnets 34 each include a flat face or surface 36 configured to cooperate with flat faces 37 defined by the polygonal shaped core 32. The magnets 34 may be attached to the core 32 by any manner accepted in the art. As shown in FIG. 2, the core 32 and magnets 34, when assembled, will be enclosed by a compressive outer sleeve 39. The rotor 30 further includes a plurality of titanium filler pieces 38.

The titanium filler pieces 38 occupy voids or spaces 40 formed between adjacent permanent magnets 34. The titanium filler pieces 38 are preferably shaped to completely fill the voids 40 between the adjacent permanent magnets 34. The titanium filler pieces 38 may take any suitable shape to fill the voids 40 between the adjacent permanent magnets 34. The titanium filler pieces 38 of the present invention are particularly suitable for use with alternator rotors 30 having four (4) or more poles (i.e., permanent magnets 34). The titanium filler pieces 38 may be made of titanium or titanium alloys. The filler pieces 38 may be used to retrofit existing rotors.

As best seen in FIG. 2, the permanent magnets 31 have a substantial solid rectangular shape, although an outer surface is arcuate shaped as shown in FIG. 3. A cross-sectional shape of the permanent magnet 34 includes 3 straight sides and an arcuate side. Likewise, the filler pieces have a substantially solid triangular shape, although an outer surface is arcuate shaped. A cross sectional shape of the filler pieces 38 includes two straight lines and an arcuate side. The arcuate side of the permanent magnets 34 and the filler pieces have a radius approximately equal to the inner radius of the outer sleeve 39.

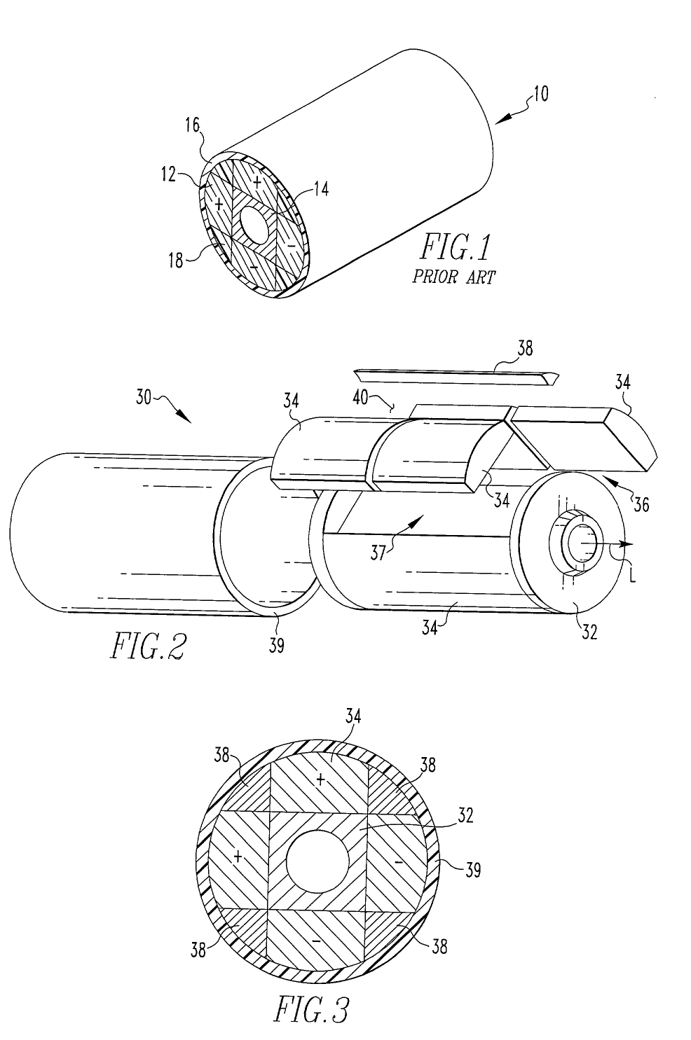

FIG. 2 shows the general method of forming the alternator rotor of the present invention. The permanent magnets 31 are arranged around the rotating core 32 with the flat faces 36 of the permanent magnets 34 contacting the flat faces 37 defined by the polygonal shaped core 32. The titanium filler pieces 38 are placed in the voids (40) defined between the adjacent permanent magnets 34. The entire assembly is enclosed by the compressive outer sleeve 39, with the core 32, permanent magnets 34, and titanium filler pieces 38 enclosed within the outer sleeve 39. The titanium filler pieces 38 may be used to replace the epoxy resin filler pieces used in connection with the prior art alternator rotor 10 shown in FIG. 1. Thus, the existing alternator rotor 10 shown in FIG. 1 may be retrofitted with the titanium filler pieces 38 in accordance with the present invention.

The titanium filler pieces 38 of the present invention provide several advantages over commonly used epoxy resin corner filler pieces. First, the titanium filler pieces 38 are well suited to resist the high temperatures that alternator rotors are typically exposed to when incorporated into larger electrical machinery. Secondly, the titanium filler pieces 38 are better able to withstand compressive forces acting on the filler pieces 38 by the compressive outer sleeve of an alternator rotor. Further, when in operation the permanent magnets 34 of the alternator rotor 30 generate centrifugal forces that act upon the sleeve 36, which then creates inward, flattening forces that act on the corners of the titanium filler pieces 38. The titanium material comprising the filler pieces 38 is better able withstand this “flattening” than epoxy resin corner filler pieces that are commonly used in the art. In addition, the titanium material comprising the filler pieces provides significant advantages over aluminum and aluminum impregnated epoxy because the titanium material does not exhibit the thermal expansion properties of aluminum, and aluminum impregnated epoxy exhibits the same disadvantages discussed previously with epoxy resin. Thus, the corner filler pieces 38 made of titanium or titanium alloy are a new, nonobvious, and significant improvement over the prior art.

The present invention was described herein according a preferred embodiment. Obvious modifications and alterations of the present invention may be made without departing from the spirit and scope of the present invention. The present invention is defined in the appended and equivalents thereto.

What is claimed is:

1. An alternator rotor, comprising:
a rotating core defining a plurality of core faces;
a plurality of permanent magnets cooperating with the core faces, with the permanent magnets defining voids between adjacent permanent magnets each of said permanent magnets have a plurality of permanent magnet faces, a respective permanent magnet face of each of the permanent magnets cooperating with a respective core face;
a plurality of titanium filler pieces positioned, respectively, in the voids defined between adjacent permanent magnets; and
a compressive outer sleeve enclosing the core, permanent magnets, and titanium filler pieces.

2. The alternator rotor of claim 1, wherein the titanium filler pieces are titanium alloy.

3. The alternator rotor of claim 1, wherein the outer sleeve is made of a material selected from the group consisting of metal, epoxy resin, or a composite of metal and epoxy resin.

4. The alternator rotor of claim 1, wherein the core is made of ferromagnetic material.

5. The alternator rotor of claim 1, wherein at least four permanent magnets are arranged around the core.

6. The alternator rotor of claim 1, wherein the permanent magnets are substantially a solid rectangular shaped and the cooperating titanium filler pieces are substantially triangular shaped to fit within the voids defined between adjacent permanent magnets.

7. An alternator as claimed in claim 1 wherein core faces include a flat face.

8. An alternator as claimed in claim 1, wherein each of the permanent magnets includes a flat permanent magnet face.

9. An alternator as claimed in claim 1, wherein each of the permanent magnets include a flat permanent magnet face cooperating in a respective flat core face.

10. A method of assembling an alternator rotor, comprising the steps of:
providing a rotating core defining a plurality of flat faces;
arranging a plurality of permanent magnets around the core, with the permanent magnets having flat faces cooperating with the flat faces of the core, and with the permanent magnets defining voids between adjacent permanent magnets;
positioning a plurality of titanium filler pieces in the voids defined between adjacent permanent magnets; and
enclosing the core, permanent magnets, and titanium filler pieces with a compressive outer sleeve.

11. The method of claim 10, wherein the titanium filler pieces are titanium alloy.

12. The alternator rotor of claim 10, wherein the core is made of ferromagnetic material.

13. The alternator rotor of claim 10, wherein at least four permanent magnets are arranged around the core.

14. The alternator rotor of claim 10, wherein the permanent magnets are substantially a solid rectangular shaped and the cooperating titanium filler pieces are substantially a solid triangular shaped to fit within the voids defined between adjacent permanent magnets.

15. A method of retrofitting corner filler pieces in an existing alternator rotor, comprising the steps of:
providing an existing alternator rotor having a central core, permanent magnets arranged around the central core, corner filler pieces separating adjacent permanent magnets, and an outer sleeve, with the outer sleeve enclosing the central core, permanent magnets, and corner filler pieces; and
removing the existing corner filler pieces and replacing the existing corner filler pieces with titanium filler pieces.

16. The method of claim 12, wherein the titanium filler pieces are titanium alloy.
